(19) United States
(12) Patent Application Publication
(10) Pub. No.: US 2018/0290352 A1
(43) Pub. Date: Oct. 11, 2018

(54) METHOD FOR MANUFACTURING SEAT CUSHION MATERIAL

(71) Applicant: TOYOTA BOSHOKU KABUSHIKI KAISHA, Aichi-ken (JP)

(72) Inventor: Tomohiko INOUE, Aichi-ken (JP)

(73) Assignee: TOYOTA BOSHOKU KABUSHIKI KAISHA, Aichi-ken (JP)

(21) Appl. No.: 15/949,693

(22) Filed: Apr. 10, 2018

(30) Foreign Application Priority Data
Apr. 11, 2017 (JP) 2017-078364

(51) Int. Cl. B29C 44/58; B29C 44/12

(52) U.S. Cl. CPC B29C 44/58; B29C 44/1271; B29C 44/1285; B29L 2031/771; B29K 2623/12; B29K 2995/0063; B29K 2623/06

(57) ABSTRACT

A method for manufacturing a seat cushion material, the seat cushion material including a front layer part and a back layer part, the back layer part having a back side surface, and a concave portion being provided in the back side surface, the method including: preparing for molding the seat cushion material by attaching the back layer part to an upper die which has an upper cavity surface and a convex portion that can be fitted into the concave portion in such a manner that the back side surface is brought into contact with the upper cavity surface; molding the seat cushion material by adding foamed resin raw material forming the front layer part on a lower cavity surface of a lower die and then by closing the upper die to which the back layer part is attached; and demolding the molded seat cushion material.

### CROSS-REFERENCE TO RELATED APPLICATIONS

This application claims priority from Japanese Patent Application No. 2017-078364 filed on Apr. 11, 2017, the entire contents of which are incorporated herein by reference.

### TECHNICAL FIELD

The disclosure relates to a method for manufacturing a seat cushion material constituting a vehicle seat.

### BACKGROUND

A pad body having a two-layer structure is known as a cushion material for a vehicle seat. JP-A-2010-125138 discloses a pad body having a two-layer structure in which a front layer pad is a urethane foam obtained by foam-molding a polyurethane resin and a back layer pad is a foamed body obtained by foam-molding AS resin (copolymer of styrene and acrylonitrile).

Typically, a die is used for manufacturing the pad body. The die has an upper die and a lower die, and a cavity corresponding to a shape of the pad body is formed between the upper die and the lower die when the upper die is closed with respect to the lower die. A cavity surface of the lower die is formed in a shape corresponding to a shape of a front surface portion side (seating surface side) of the pad body, and a cavity surface of the upper die is formed in a shape corresponding to a shape of a back surface portion side (side opposite to the seating surface) of the pad body. Further, in a state where a back surface of the back layer pad is temporarily held on the cavity surface of the upper die by mechanical fitting or adhesion such as a double-sided tape, the pad body is manufactured by pouring foamed polyurethane resin raw material onto the cavity surface of the lower die, closing the upper die with respect to the lower die, and performing foam-molding.

In the method for manufacturing the pad body having the two-layered structure disclosed in JP-A-2010-125138, there is a problem that a part of the foamed polyurethane resin raw material intrudes between the cavity surface of the upper die and the back surface of the back layer pad from an end portion of the back surface of the back layer pad in contact with the cavity surface of the upper die and the part is foamed and cured therein in the process of foaming and curing the foamed polyurethane resin raw material. When the part of the foamed polyurethane resin raw material intrudes between the cavity surface of the upper die and the back surface of the back layer pad and the part is foamed and cured therein, there is a possibility that an underfill occurs at a part of the front layer pad. Further, when attempting to increase the amount of the foamed polyurethane resin raw material added in order to prevent the occurrence of the underfill, the material cost and weight of the pad body are increased.

### SUMMARY

An object is to provide a method capable of manufacturing a seat cushion material in which a front layer part and a back layer part that is disposed on the side of the front layer part opposite to a seating surface and that has a lower density than the front layer part are integrated while suppressing the occurrence of defects such as voids.

An aspect of the present disclosure is a method for manufacturing a seat cushion material, the seat cushion material including a front layer part disposed on a seating surface side, and a back layer part disposed on a side of the front layer part opposite to the seating surface and having a higher rigidity and a lower density than the front layer part, the seat cushion material having a layered structure in which the front layer part and the back layer part are integrated, the back layer part having a back side surface constituting at least a part of the surface on the side of the seat cushion material opposite to the seating surface, and a concave portion that extends along at least a part of a peripheral edge portion of the back side surface and is recessed toward the seating surface side being provided in the back side surface, the method including: preparing for molding the seat cushion material by attaching the back layer part to an upper die which has an upper cavity surface corresponding to the surface on the side of the seat cushion material opposite to the seating surface and which has a convex portion that can be fitted into the concave portion in such a manner that the back side surface is brought into contact with the upper cavity surface in a state where the convex portion is fitted into the concave portion; molding the seat cushion material by adding foamed resin raw material forming the front layer part on a lower cavity surface of a lower die which corresponds to the surface on the seating surface side of the seat cushion material and then by closing the upper die to which the back layer part is attached so as to integrate the front layer part with the back layer part; and demolding the molded seat cushion material.

### BRIEF DESCRIPTION OF DRAWINGS

FIG. 1 is a perspective view of a seat cushion material manufactured by an embodiment of the disclosure;

FIG. 2 is an exploded perspective view of the seat cushion material manufactured by the above embodiment;

FIG. 3 is a plan view of the seat cushion material manufactured by the above embodiment;

FIG. 4 is a sectional view taken along the line IV-IV in FIG. 3;

FIG. 5 is a sectional view taken along the line V-V in FIG. 3;

FIG. 6 is a sectional view taken along the line VI-VI in FIG. 3;

FIG. 7 is a sectional view of a section corresponding to FIG. 4, showing a die for molding the seat cushion material according to the above embodiment. FIG. 7 shows a state in which a cavity is hollow;

FIG. 8 is a sectional view of the section corresponding to FIG. 4, showing the die for molding the seat cushion material according to the above embodiment. FIG. 8 shows a state in which a back layer part is attached to an upper die;

FIG. 9 is an expanded view of the portion IX in FIG. 8;

FIG. 10 is a sectional view of a section corresponding to FIG. 4, showing the die for molding the seat cushion material according to the above embodiment. FIG. 10 shows a state in which the seat cushion material is molded; and

FIG. 11 is a sectional view of a section corresponding to FIG. 6, showing the die for molding the seat cushion material according to the above embodiment. FIG. 11 shows a state in which the seat cushion material is molded.

### DETAILED DESCRIPTION

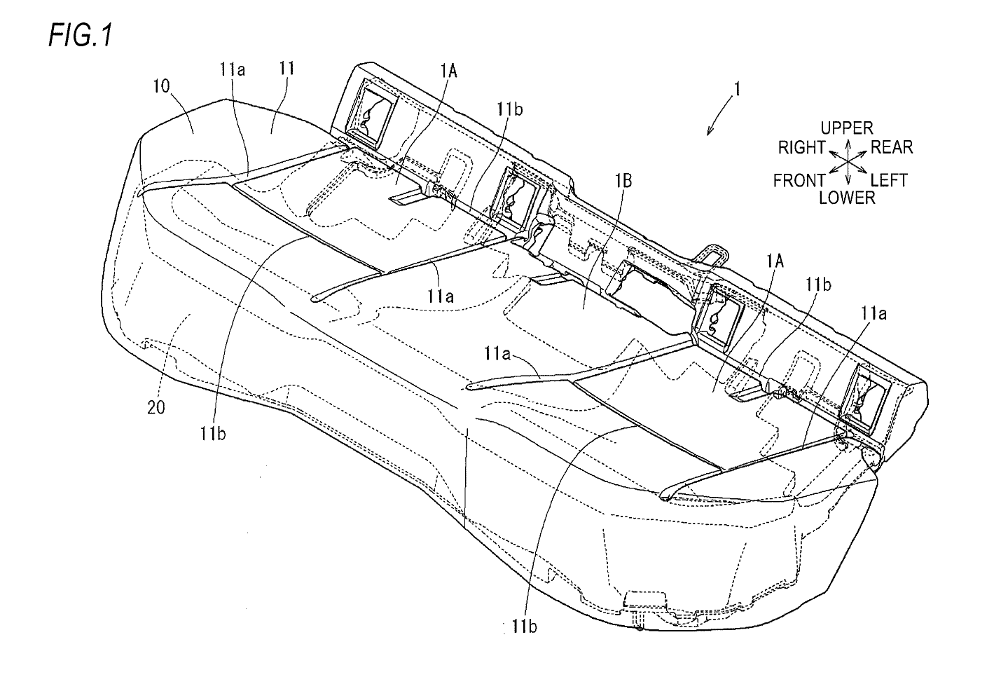

A seat cushion material manufactured by an embodiment according to a manufacturing method of the disclosure will be described with reference to FIGS. 1 to 6. In each of the figures, respective directions of an automobile when a seat cushion frame is mounted on a floor of the automobile are indicated by arrows. In the following, the description relating to directions is made with reference to these directions.

FIG. 1 shows a cushion pad 1 that is a seat cushion material manufactured by a manufacturing method according to the disclosure. The cushion pad 1 is used for a seat cushion of a three-seat bench seat and has a length in a left and right direction that is substantially the same as a width of a cabin. A cushion cover (not shown) that covers the surface of the cushion pad 1 is covered on the cushion pad 1 to form a seat cushion. Further, a seat back (not shown) having the same configuration is assembled in a state of being erected on a rear end portion of the seat cushion and is attached to a cabin floor to form a rear seat. Here, the cushion pad 1 corresponds to the “seat cushion material” in the claims.

As shown in FIGS. 1 to 6, the cushion pad 1 includes a pair of left and right seating parts 1A, and a center seating part 1B disposed between the left and right seating parts 1A. Further, the cushion pad 1 includes a front layer pad 10 disposed on the front side that is a seating surface side, and a back layer pad 20 disposed on the back side that is a lower side of the front layer pad 10. Here, the front layer pad 10 corresponds to the “front layer part” and the back layer pad 20 corresponds to the “back layer part” in the claims.

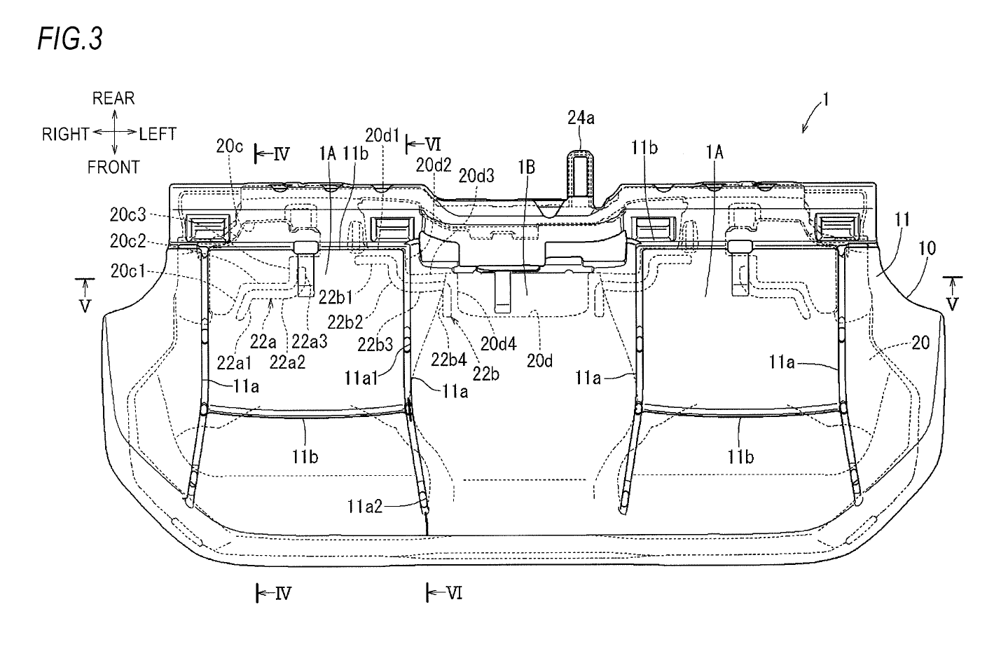

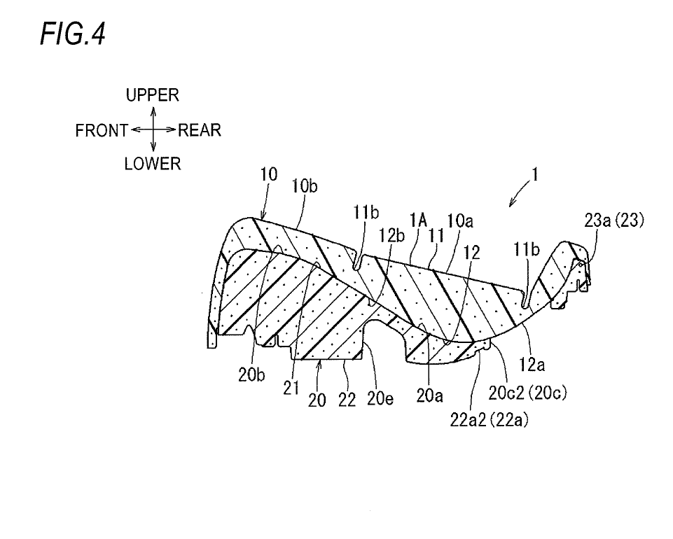

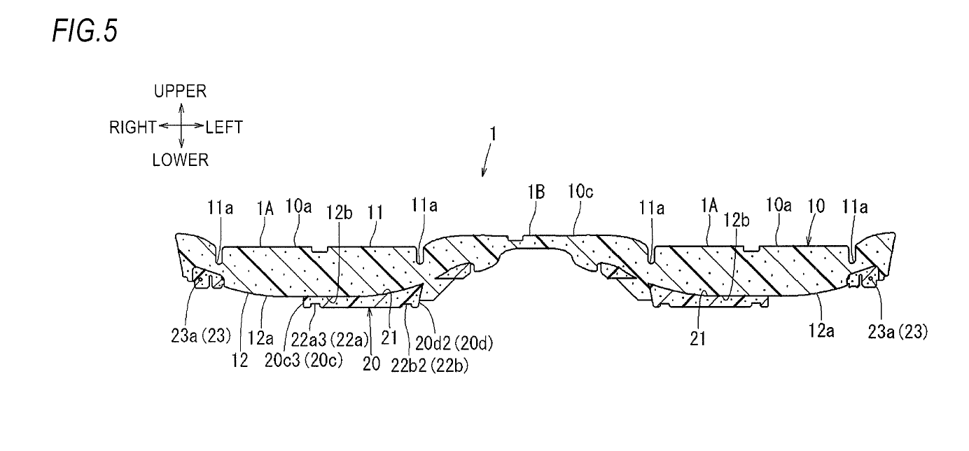

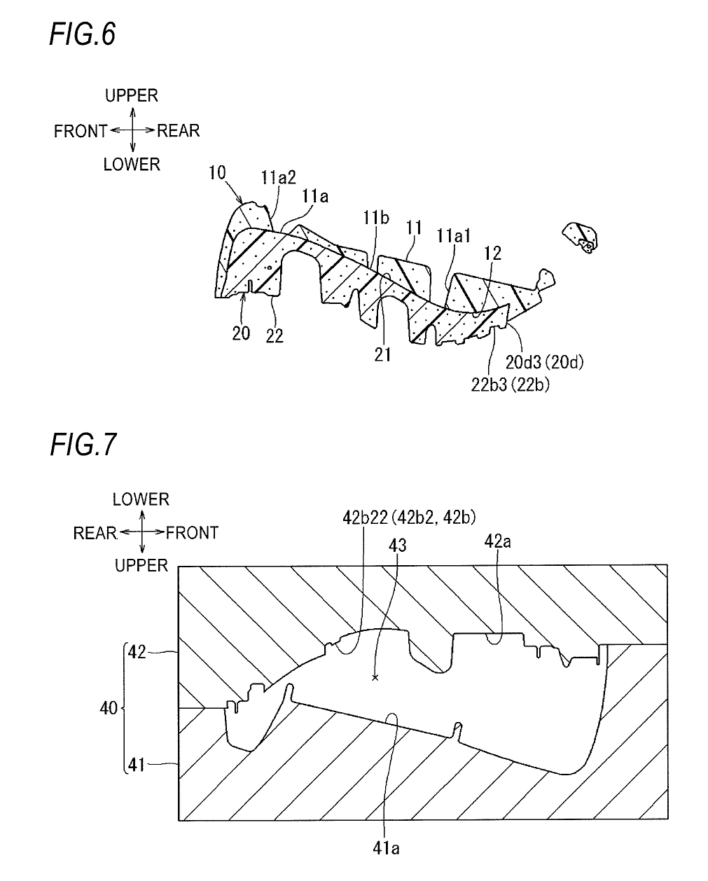

The front layer pad 10 is formed of urethane foam obtained by foam-molding polyurethane resin and the density thereof is set to, for example, about 0.045±0.005 g/cm³. The front layer pad 10 includes a front surface portion 11 that has a shape and an area occupying the entire surface on the seating surface side of the cushion pad 1 and a back surface portion 12 that forms a part of the cushion pad 1 on the side opposite to the seating surface. As shown in FIG. 4, the front layer pad 10 is configured such that a buttock support portion 10a which is a portion for supporting a buttock of an occupant seated on each of the left and right seating parts 1A is formed thicker than a thigh support portion 10b which is a portion for supporting a thigh of an occupant seated on each of the left and right seating parts 1A. The buttock support portion 10a having a high seating pressure is more elastically supported than the thigh support portion 10b having a low seating pressure, and thus, the comfort of sitting is improved. Further, as shown in FIG. 5, in the front layer pad 10, the buttock support portion 10c of the center seating part 1B is formed to be thinner than the buttock support portion 10a of each of the left and right seating parts 1A. Although not shown, the thickness of the thigh support portion of the center seating part 1B is also set to be substantially equal to the thickness of the buttock support portion 10c. As shown in FIG. 3, a pair of longitudinal grooves 11a extending in the front and rear direction on the left and right sides of each of the left and right seating parts 1A, and two lateral grooves 11b connecting the pair of longitudinal grooves 11a to each other at the rear end portion and at the substantially center portion in the front and rear direction are formed on the front surface portion 11 of the front layer pad 10. The longitudinal grooves 11a and the lateral grooves 11b are formed in a substantially U-shape having a transverse cross-section opened upward. As shown in FIG. 6, in the portions of the longitudinal grooves 11a, a rear hole portion 11a1 is formed as a hole reaching a front side portion 21 of the back layer pad 20 at the portion corresponding to the buttock support portion 10a, and a front hole portion 11a2 is formed as a hole reaching the front side portion 21 of the back layer pad 20 at the portion corresponding to the thigh support portion 10b. Both the rear hole portion 11a1 and the front hole portion 11a2 are formed in such a manner that the width in the left and right direction is substantially equal to the width in the left and right direction of the longitudinal grooves 11a and its length in the front and rear direction is gradually shortened from an upper end portion toward a lower end portion.

The back layer pad 20 is a bead foam molded product of an olefin resin such as polypropylene or polyethylene and the density thereof is set to about 0.03 g/cm³. The back layer pad 20 is formed to have a lower density and a higher elastic modulus than the front layer pad 10. The volume of the back layer pad 20 is set as about one-third of the total volume of the cushion pad 1.

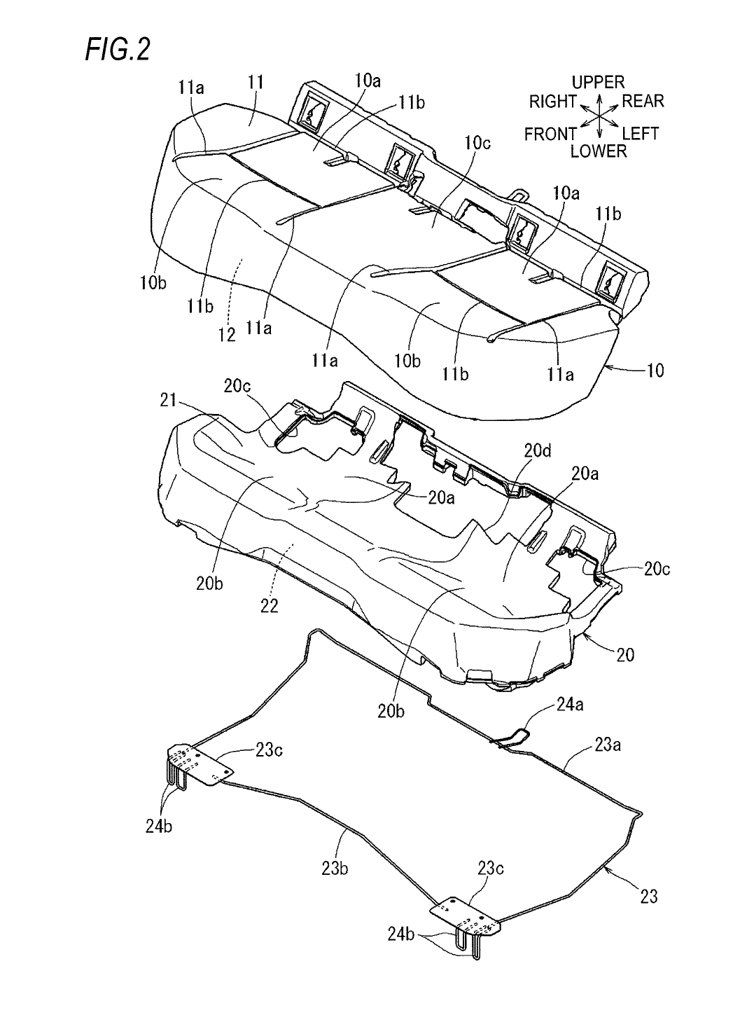

As shown in FIGS. 2, 4 and 5, the back layer pad 20 has the front side portion 21 abutting against a part of the back surface portion 12 of the front layer pad 10 and a back side portion 22 forming a part of the back side of the cushion pad 1. As shown in FIG. 4, the back layer pad 20 is formed in such a manner that a buttock support portion 20a that is a portion for supporting a buttock of an occupant seated on each of the left and right seating parts 1A is thinner than a thigh support portion 20b that is a portion for supporting a thigh of an occupant seated on each of the left and right seating parts 1A. This is intended to secure a predetermined thickness of the cushion pad 1 so as to correspond to the buttock support portion 10a and the thigh support portion 10b of the front layer pad 10. In the back layer pad 20, a pair of left and right through-holes 20c penetrating in the upper and lower direction is provided near the outer side in the left and right direction (width direction) of the rear portion of each of the left and right seating parts 1A. Further, in the back layer pad 20, one central through-hole 20d is provided from the rear portion of the center seating part 1B to the vicinity of the inner side in the left and right direction (width direction) of the rear portion of each of the left and right seating parts 1A. In this manner, when the front layer pad 10 is integrally foam-molded with respect to the back layer pad 20, a part of the front layer pad 10 intrudes into the left and right through-holes 20c and the central through-hole 20d of the back layer pad 20 and is foamed and cured therein, thereby forming an exposed back surface portion 12a that is a part of the back surface portion 12 of the front layer pad 10. The exposed back surface portion 12a forms a back side of the cushion pad 1 together with the back side portion 22 of the back layer pad 20. When integrally foam-molding the front layer pad 10, the front side portion 21 of the back layer pad 20 is joined to a joined back surface portion 12b, which is a portion other than the exposed back surface portion 12a of the back surface portion 12 of the front layer pad 10. As shown in FIG. 4, in the back side portion 22 of the back layer pad 20, a thickness reduction hole 20e for saving used material may be provided at a predetermined position as necessary. Here, the back side portion 22 corresponds to the “back side surface” in the claims.

As shown in FIGS. 2, 4 and 5, the frame 23 made of an iron wire is inserted inside front, rear, left and right peripheral edge portions of the back layer pad 20. The frame 23 includes a substantially U-shaped main frame 23a opened forward in a top view, a front frame 23b disposed in the opening side of the main frame 23a, and two plate-like connecting frames 23c for connecting the main frame 23a and the front frame 23b. Further, the frame 23 includes one rear locking frame 24a and four front locking frames 24 for locking the cushion pad 1 on a vehicle floor. An end portion of the opening side of the main frame 23a and the left and right end portions of the front frame 23b are connected by being welded to the connecting frame 23c. Further, the rear locking frame 24a is fixed to the main frame 23a by welding, and the front locking frames 24 are fixed to the connecting frame 23c by welding. When performing the bead-foam molding of the back layer pad 20, the frame 23 is integrated by placing the main frame 23a, the front frame 23b and the connecting frames 23c formed in a frame shape in predetermined positions inside a die and integrally foam-molding them. The frame 23 not only functions as a framework, but also functions to be held by being attracted by a magnet embedded in an upper cavity surface of an upper die when attaching the back layer pad 20 to the upper cavity surface at the time of molding the cushion pad 1.

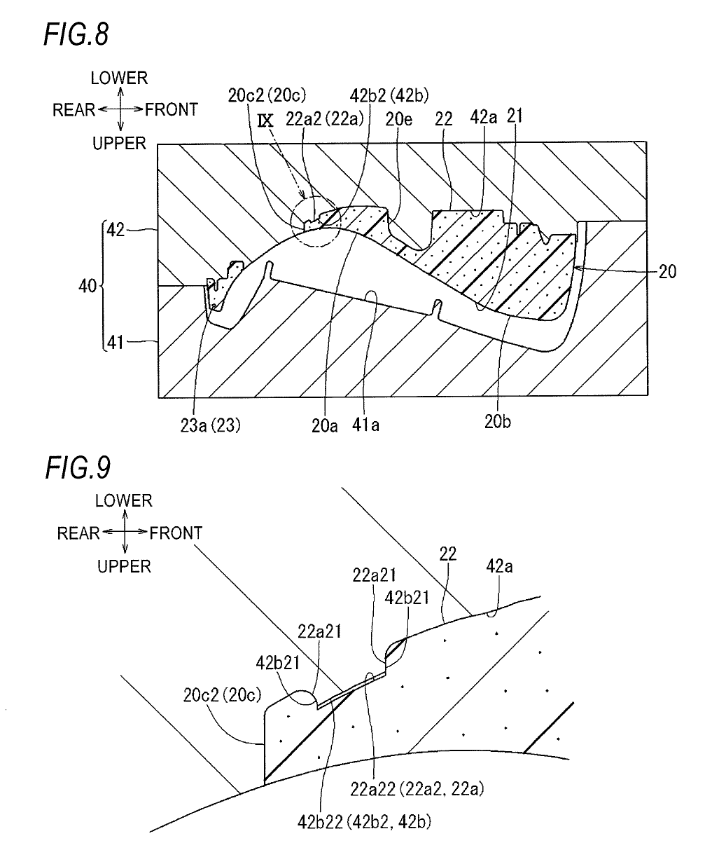

As shown in FIGS. 3 to 5, substantially U-shaped first fitting grooves 22a are formed in the back side portion 22 of the back layer pad 20. The first fitting grooves 22a extend to be bent along front end portions of the left and right through-holes 20c and have a cross section opened downward. Specifically, since the first fitting grooves 22a are bilaterally symmetrical, the right first fitting groove 22a will be described as a representative. The first fitting groove 22a has a right portion 22a1 that extends along a front right end portion 20c1 extending in the front and right direction of the right through-hole 20c. Further, the first fitting groove 22a has a central portion 22a2 that extends along a front middle end portion 20c2 extending toward the left side from a rear end portion of the front right end portion 20c1 of the right through-hole 20c. Furthermore, the first fitting groove 22a has a left portion 22a3 that extends along a front left end portion 20c3 extending toward the rear side from a left end of the front middle end portion 20c2 of the right through-hole 20c. As shown in FIGS. 8 and 9, a gap between a pair of groove side surface portions 22a21 of the central portion 22a2 of the first fitting groove 22a is set to about 10 mm, and a distance from the front middle end portion 20c2 of the right through-hole 20c to the groove side surface portion 22a21 on the side close to the front middle end portion 20c2 is set to about 10 mm. The relationship between the right portion 22a1 and the left portion 22a3 of the first fitting groove 22a, and the front right end portion 20c1 and the front left end portion 20c3 of the right through-hole 20c is also similar to the relationship between the central portion 22a2 and the front middle end portion 20c2. That is, a groove width (distance between groove side surface portions) of the first fitting groove 22a is set to about 10 mm. Further, a distance between the front right end portion 20c1 and the groove side surface portion of the right portion 22a1 on the side close to the front right end portion 20c1, a distance between the front middle end portion 20c2 and the groove side surface portion of the central portion 22a2 on the side close to the front middle end portion 20c2, and a distance between the front left end portion 20c3 and the groove side surface portion of the left portion 22a3 on the side close to the front left end portion 20c3 are set to about 10 mm. Further, as shown in FIGS. 8 and 9, a distance from a general surface of the back side portion 22 to a groove bottom surface portion 22a22 is a depth of the central portion 22a2 of the first fitting groove 22a and is set to about 3 mm to 4 mm. The right portion 22a1 and the left portion 22a3 of the first fitting groove 22a are also the same as the central portion 22a2. However, the groove width of the first fitting groove 22a and the distance between the front end portion of the right through-hole 20c and the groove side surface portion of the first fitting groove 22a on the side close to the front end portion of the right through-hole 20c can be appropriately selected in the range of 3 mm to 50 mm. Here, the first fitting groove 22a corresponds to the “concave portion” in the claims. Further, the front right end portion 20c1, the front middle end portion 20c2 and the front left end portion 20c3 correspond to the “peripheral edge portion” in the claims, respectively.

As shown in FIGS. 3 and 5, substantially U-shaped second fitting grooves 22b are formed in the back side portion 22 of the back layer pad 20. The second fitting grooves 22b extend to be bent along a front end portion of the central through-hole 20d and have a cross section opened downward. Specifically, since the second fitting grooves 22b are bilaterally symmetrical, the right second fitting groove 22b will be described as a representative. The second fitting groove 22b has a right portion 22b1 that extends along a front right end portion 20d1 extending toward the left side from a front right end portion of the central through-hole 20d. Further, the second fitting groove 22b has a central right portion 22b2 that extends along a front middle right end portion 20d2 extending toward the front side from a right end portion of the front right end portion 20d1 of the central through-hole 20d. Furthermore, the second fitting groove 22b has a central left portion 22b3 that extends along a front middle left end portion 20d3 extending toward the left side from a front end portion of the front middle right end portion 20d2 of the central through-hole 20d. In addition, the second fitting groove 22b has a left portion 22b4 that extends along a front left end portion 20d4 extending toward the front side from a left end portion of the front middle left end portion 20d3 of the central through-hole 20d. A groove width of the second fitting groove 22b is set to about 10 mm, and a distance from a front end portion of the central through-hole 20d to the groove side surface portion of the second fitting groove 22b on the side close to the front end portion of the central through-hole 20d is set to about 10 mm. That is, a distance between the front right end portion 20d1 and the groove side surface portion of the right portion 22b1 on the side close to the front right end portion 20d1, a distance between the front middle right end portion 20d2 and the groove side surface portion of the central right portion 22b2 on the side close to the front middle right end portion 20d2, a distance between the front middle left end portion 20d3 and the groove side surface portion of the central left portion 22b3 on the side close to the front middle left end portion 20d3, and a distance between the front left end portion 20d4 and the groove side surface portion of the left portion 22b4 on side close to the front left end portion 20d4 are set to about 10 mm. Further, a depth of the second fitting groove 22b is set to about 3 mm to 4 mm. However, the groove width of the second fitting groove 22b and the distance from the front end portion of the central through-hole 20d to the groove side surface portion of the second fitting groove 22b on the side close to the front end portion of the central through-hole 20d can be appropriately selected in the range of 3 mm to 50 mm. Here, the second fitting groove 22b corresponds to the “concave portion” in the claims. Further, the front right end portion 20d1, the front middle right end portion 20d2, the front middle left end portion 20d3, and the front left end portion 20d4 correspond to the “peripheral edge portion” in the claims, respectively.

A method for manufacturing the cushion pad 1 will be described with reference to FIGS. 7 to 10. The indication of directions in FIGS. 7 to 10 is consistent with the directions of the cushion pad 1. The back layer pad 20 is molded by the bead-foam molding of an olefin resin in a state where the frame 23 is previously inserted therein. The bead-foam molding refers to a molding method in which pre-foamed beads obtained by pre-foaming raw material beads obtained by impregnating a pellet of an olefin resin with foaming agent are placed in a die cavity and heated by steam, and thus the pre-foamed beads are further expanded to have a shape along the die cavity. As shown in FIG. 7, a urethane foam molding die 40 for molding the cushion pad 1 includes a lower die 41 and an upper die 42 that can be opened and closed with respect to the lower die 41. Each of the lower die 41 and the upper die 42 has a die temperature adjustment function for molding the urethane foam resin and a lock mechanism (not shown) for closing the die. A lower cavity surface 41a having a shape corresponding to the front surface portion 11 of the front layer pad 10 which is a front side shape of the cushion pad 1 is formed in the lower die 41. An upper cavity surface 42a having a shape corresponding to the exposed back surface portion 12a of the front layer pad 10 and the back side portion 22 of the back layer pad 20, which are back side shapes of the cushion pad 1, is formed in the upper die 42. In a state where the upper die 42 is closed with respect to the lower die 41, a cavity 43 surrounded by the lower cavity surface 41a and the upper cavity surface 42a is formed between the lower die 41 and the upper die 42.

As shown in FIG. 8, the back side portion 22 of the back layer pad 20 is held by being brought into contact with the upper cavity surface 42a of the upper die 42. A plurality of permanent magnets (not shown) for attracting and holding the frame 23 inserted in the back layer pad 20 by a magnetic force is embedded in predetermined positions of the upper cavity surface 42a. The back layer pad 20 is held on the upper cavity surface 42a by the magnetic force and the concavo-convex fitting between the back side portion 22 and the upper cavity surface 42a. This process corresponds to the “preparing for molding the seat cushion material” in the claims.

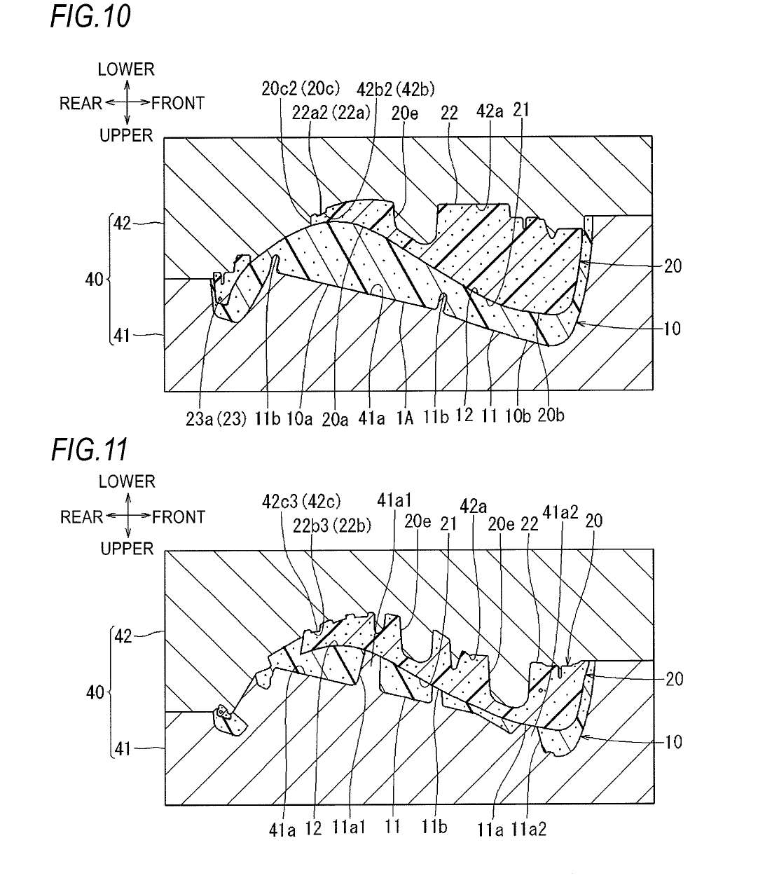

The state shown in FIG. 8 corresponds to a state in which the upper die 42 to which the back layer pad 20 is attached is closed with respect to the lower die 41. At this time, as shown in FIGS. 6 and 11, the back layer pad 20 is pressed against the upper cavity surface 42a by a rear protrusion 41a1 and a front protrusion 41a2 corresponding to the shapes of the rear hole portion 11a1 and the front hole portion 11a2 in the portion of the longitudinal groove 11a. Further, at this time, as shown in FIG. 9, the central portion 22a2 of the first fitting groove 22a of the back layer pad 20 and a central portion 42b2 of a first convex portion 42b provided in the upper cavity surface 42a corresponding to the central portion 22a2 are fitted to each other, and the groove side surface portions 22a21 on the front and rear sides of the central portion 22a2 are brought into contact with side wall surfaces 42b21 on the front and rear sides of the central portion 42b2. A top wall portion 42b22 of the central portion 42b2 of the first convex portion 42b faces the groove bottom surface portion 22a22 of the central portion 22a2 of the first fitting groove 22a with a slight gap therebetween. Although not shown, the right portion 22a1 and the left portion 22a3 of the first fitting groove 22a of the back layer pad 20 are fitted to a right portion and a left portion of the first convex portion 42b in a similar manner. Further, as shown in FIG. 11, the central left portion 22b3 of the second fitting groove 22b of the back layer pad 20 and a central left portion 42c3 of a second convex portion 42c provided in the upper cavity surface 42a corresponding to the central left portion 22b3 are fitted to each other, similar to the central portion 22a2 of the first fitting groove 22a and the central portion 42b2 of the first convex portion 42b corresponding thereto. That is, a side wall surface of the second convex portion 42c is fitted in a state of being in contact with a groove side wall surface of the second fitting groove 22b. In this way, in the molding process to be described later, the urethane foamed resin raw material that has entered the right through-hole 20c and the central through-hole 20d is blocked at an engagement portion between the first fitting groove 22a and the first convex portion 42b or an engagement portion between the second fitting groove 22b and the second convex portion 42c. Thus, the urethane foamed resin raw material does not intrude toward the inside of the back layer pad 20 from that position. Here, the first convex portion 42b and the second convex portion 42c correspond to the “convex portion” in the claims, respectively. Further, the rear protrusion 41a1 and the front protrusion 41a2 correspond to the “protrusion” in the claims, respectively.

In a state where the back side portion 22 of the back layer pad 20 is held by being brought into contact with the upper cavity surface 42a of the upper die 42, the foamed urethane resin raw material M is added on the lower cavity surface 41a of the lower die 41, and then, the upper die 42 is closed with respect to the lower die 41, as shown in FIG. 8. Then, the foamed urethane resin raw material M is foamed to fill the cavity 43 while increasing its volume. After a predetermined time for a foam curing has passed, the front layer pad 10 is formed. This state is shown in FIG. 10, and this process corresponds to the “molding the seat cushion material” in the claims. By this molding process, the front layer pad 10 is formed and integrated with the back layer pad 20, so that the cushion pad 1 is manufactured. Then, the upper die 42 is opened with respect to the lower die 41 and the molded cushion pad 1 is removed from the die. This process corresponds to the “demolding the molded seat cushion” in the claims. Here, the foamed urethane resin raw material M corresponds to the “foamed resin raw material” in the claims.

In the manufacturing process as described above, the following operational effects are achieved. When performing the foam-molding of the front layer pad 10 with the foamed urethane resin raw material M, the back layer pad 20 is attached to the upper die 42 in such a manner that the back side portion 22 is brought into contact with the upper cavity surface 42a of the upper die 42 in a state where the first convex portion 42b and the second convex portion 42c are fitted to the first fitting groove 22a and the second fitting groove 22b, respectively. In this way, at least in the portion where the first fitting groove 22a and the second fitting groove 22b are provided, it is possible to make it difficult for the foamed urethane resin raw material M to flow beyond the first fitting groove 22a and the second fitting groove 22b and intrude between the upper cavity surface 42a and the back side portion 22 of the back layer pad 20 into the inner side in the process of foaming and curing the foamed urethane resin raw material M. Further, it is possible to suppress the occurrence of defects such as voids in the front layer pad 10 due to the lack of the foamed urethane resin raw material M forming the front layer pad 10.

Further, the distance between the front end portion of the right through-hole 20c and the groove side surface portion of the first fitting groove 22a on the side close to the front end portion of the right through-hole 20c, and the distance between the front end portion of the central through-hole 20d and the groove side surface portion of the second fitting groove 22b close to the front end portion of the central through-hole 20d are set to a length of ½ to 1 of a width of the groove bottom surface portion 22a22. In this way, in the process of foaming and curing the foamed urethane resin raw material M, it is possible to reduce the amount of the foamed urethane resin raw material M that intrudes between the upper cavity surface 42a and the back side portion 22 of the back layer pad 20 from the front end portion of the right through-hole 20c or the front end portion of the central through-hole 20d to the first fitting groove 22a or the second fitting groove 22b. As a result, it is possible to further suppress the occurrence of defects such as voids in the front layer pad 10 due to the lack of the foamed urethane resin raw material M forming the front layer pad 10.

Furthermore, the lower cavity surface 41a is provided with a plurality of rear protrusions 41a1 and a plurality of front protrusions 41a2 which are brought into contact with the front side portion 21 of the back layer pad 20 and press the back layer pad 20 against the upper cavity surface 42a when the upper die 42 to which the back layer pad 20 is attached is closed with respect to the lower die 41. Further, the rear protrusions 41a1 and the front protrusions 41a2 are disposed at positions not overlapping with the first convex portion 42b and the second convex portion 42c as viewed from the top in a direction perpendicular to the lower cavity surface 41a (it is noted that the rear hole portions 11a1 and the front hole portions 11a2 corresponding to the rear protrusions 41a1 and the front protrusions 41a2 are disposed at positions not overlapping with the first fitting groove 22a and the second fitting groove 22b corresponding to the first convex portion 42b and the second convex portion 42c, as shown in FIG. 3). In this way, at the positions where the first convex portion 42b and the second convex portion 42c do not overlap with the rear protrusions 41a1 and the front protrusions 41a2 and a force for pressing the back side portion 22 of the back layer pad 20 against the upper cavity surface 42a is weak, the first convex portion 42b and the second convex portion 42c are disposed and fitted to the first fitting groove 22a and the second fitting groove 22b of the back layer pad 20. Therefore, the intrusion of the foamed urethane resin raw material M at such a portion can be suppressed.

Although specific embodiments have been described above, the disclosure is not limited to the configurations in these embodiments, and various modifications, additions and deletions can be made without changing the spirit of the disclosure. For example, the following configurations can be adopted.

1. In the above embodiment, the first fitting groove 22a is disposed along the front end portion of the right through-hole 20c, and the second fitting groove 22b is disposed along the front end portion of the central through-hole 20d. However, the disclosure is not limited thereto. The first fitting groove and the second fitting groove may be provided at other portions, for example, at a peripheral edge portion of a front end or peripheral edge portions of left and right ends of the back layer pad 20. Furthermore, the first fitting groove 22a and the second fitting groove 22b may be connected so as to extend in the left and right direction.

2. In the above embodiment, the upper cavity surface 42a of the upper die 42 is formed so as to conform to the shape of the back side portion 22 of the back layer pad 20. However, the disclosure is not limited thereto. For example, the upper cavity surface 42a of the portion corresponding to the thickness reduction hole 20e may be configured such that it is brought into contact with an opening side peripheral edge of the thickness reduction hole 20e but is not brought into contact with the inside of the thickness reduction hole 20e.

3. In the above embodiment, the disclosure is applied to an automobile seat cushion. However, the disclosure may be applied to an automobile seat back or may be applied to a seat mounted on an airplane, a ship, a train, or the like.

The disclosure provides illustrative, non-limiting examples as follows:

A first aspect of the present disclosure is a method for manufacturing a seat cushion material, the seat cushion material including a front layer part disposed on a seating surface side, and a back layer part disposed on a side of the front layer part opposite to the seating surface and having a higher rigidity and a lower density than the front layer part, the seat cushion material having a layered structure in which the front layer part and the back layer part are integrated, the back layer part having a back side surface constituting at least a part of the surface on the side of the seat cushion material opposite to the seating surface, and a concave portion that extends along at least a part of a peripheral edge portion of the back side surface and is recessed toward the seating surface side being provided in the back side surface, the method including: preparing for molding the seat cushion material by attaching the back layer part to an upper die which has an upper cavity surface corresponding to the surface on the side of the seat cushion material opposite to the seating surface and which has a convex portion that can be fitted into the concave portion in such a manner that the back side surface is brought into contact with the upper cavity surface in a state where the convex portion is fitted into the concave portion; molding the seat cushion material by adding foamed resin raw material forming the front layer part on a lower cavity surface of a lower die which corresponds to the surface on the seating surface side of the seat cushion material and then by closing the upper die to which the back layer part is attached so as to integrate the front layer part with the back layer part; and demolding the molded seat cushion material.

According to the first aspect, when performing the foam-molding of the front layer part, the back layer part is attached to the upper die in such a manner that the back side surface is configured to be brought into contact with the upper cavity surface of the upper die in a state where the convex portion of the upper die is fitted to the concave portion. In this way, at least in the portion where the concave portion is provided, it is possible to make it difficult for the foamed resin raw material to flow beyond the concave portion and intrude into the inner side between the upper cavity surface and the back side surface of the back layer part in the process of foaming and curing the foamed resin raw material. Further, it is possible to suppress the occurrence of defects such as voids in the front layer part due to the lack of the foamed resin raw material forming the front layer part. Here, the seating surface side refers to a so-called front side that is a surface side on which an occupant sits on the seat cushion material, and the side opposite to the seating surface refers to a so-called back side.

A second aspect of the present disclosure is characterized in that in the first aspect, the concave portion includes a pair of groove side surface portions extending in a direction perpendicular to the seating surface and a groove bottom surface portion connected to end portions on the seating surface side of the pair of groove side surface portions, the concave portion is formed in a substantially U-shape in which a cross section where the end portions on the seating surface side of the pair of groove side surface portions and the groove bottom surface portion are connected with each other is opened toward the side opposite to the seating surface, and a distance from the peripheral edge portion of the back side surface to the groove side surface portion on the side close to the peripheral edge portion is set to a length of ½ to 1 of a width of the groove bottom surface portion.

According to the second aspect, in the process of foaming and curing the foamed resin raw material, it is possible to reduce the amount of the foamed resin raw material that intrudes between the upper cavity surface and the back side surface of the back layer part from the peripheral edge portion to the groove side surface portion on the side close to the peripheral edge portion. As a result, it is possible to further suppress the occurrence of defects such as voids in the front layer part due to the lack of the foamed resin raw material forming the front layer part.

A third aspect of the present disclosure is characterized in that in the first, the lower cavity surface is provided with a plurality of protrusions which is configured to be brought into contact with the seating surface side of the back layer part and is configured to press the back layer part against the upper cavity surface when the upper die to which the back layer part is attached is closed with respect to the lower die, and the plurality of protrusions is disposed at a position not overlapping with the convex portion as viewed from a direction perpendicular to the lower cavity surface.

According to the third aspect, at the position where the back layer part is not pressed against the upper cavity surface by the protrusions, the back side surface of the back layer part is less likely to be brought into close contact with the upper cavity surface, and thus, the possibility that the foamed resin raw material intrudes the positions is increased. Since the convex portion is disposed in the position and fitted to the concave portion of the back layer part, the intrusion of the foamed resin raw material at the position can be suppressed.

What is claimed is:

1. A method for manufacturing a seat cushion material, the seat cushion material including a front layer part disposed on a seating surface side, and a back layer part disposed on a side of the front layer part opposite to the seating surface and having a higher rigidity and a lower density than the front layer part, the seat cushion material having a layered structure in which the front layer part and the back layer part are integrated, the back layer part having a back side surface constituting at least a part of the surface on the side of the seat cushion material opposite to the seating surface, and a concave portion that extends along at least a part of a peripheral edge portion of the back side surface and is recessed toward the seating surface side being provided in the back side surface, the method comprising:
preparing for molding the seat cushion material by attaching the back layer part to an upper die which has an upper cavity surface corresponding to the surface on the side of the seat cushion material opposite to the seating surface and which has a convex portion that can be fitted into the concave portion in such a manner that the back side surface is brought into contact with the upper cavity surface in a state where the convex portion is fitted into the concave portion;
molding the seat cushion material by adding foamed resin raw material forming the front layer part on a lower cavity surface of a lower die which corresponds to the surface on the seating surface side of the seat cushion material and then by closing the upper die to which the back layer part is attached so as to integrate the front layer part with the back layer part; and
demolding the molded seat cushion material.

2. The method for manufacturing the seat cushion material according to claim 1,
wherein the concave portion includes a pair of groove side surface portions extending in a direction perpendicular to the seating surface and a groove bottom surface portion connected to end portions on the seating surface side of the pair of groove side surface portions,
wherein the concave portion is formed in a substantially U-shape in which a cross section where the end portions on the seating surface side of the pair of groove side surface portions and the groove bottom surface portion are connected with each other is opened toward the side opposite to the seating surface, and
wherein a distance from the peripheral edge portion of the back side surface to the groove side surface portion on the side close to the peripheral edge portion is set to a length of ½ to 1 of a width of the groove bottom surface portion.

3. The method for manufacturing the seat cushion material according to claim 1,
wherein the lower cavity surface is provided with a plurality of protrusions which is configured to be brought into contact with the seating surface side of the back layer part and is configured to press the back layer part against the upper cavity surface when the upper die to which the back layer part is attached is closed with respect to the lower die, and
wherein the plurality of protrusions is disposed at a position not overlapping with the convex portion as viewed from a direction perpendicular to the lower cavity surface.
